(19) United States
(12) Patent Application Publication
(10) Pub. No.: US 2026/0146881 A1
(43) Pub. Date: May 28, 2026

(54) Flow Meter Insert Including Vertically Offset Reflectors

(71) Applicant: Badger Meter, Inc., Milwaukee, WI (US)

(72) Inventors: Jakob Hultkvist, Luleå (SE); Jon-David Schuetze, Milwaukee, WI (US)

(21) Appl. No.: 18/960,023

(22) Filed: Nov. 26, 2024

(51) Int. Cl. G01F 1/66; G01F 1/667

(52) U.S. Cl. CPC G01F 1/662; G01F 1/667

(57) ABSTRACT

A flow insert configured to minimize the effect of an upstream bluff body for insertion in an ultrasonic meter transporting a flow stream. The flow insert includes an inlet side receiving the flow stream, an outlet side receiving the flow stream after the flow stream passes through the inlet side, a flow insert flow area between the inlet side and the outlet side, the flow insert flow area including an upper portion and a lower portion, and a flow measurement area defined by at least two transducer ports and at least an upstream and a downstream reflector defining an ultrasonic signal path through the flow measurement area, where the upstream reflector is positioned and supported by an upstream bluff body and is vertically offset from the downstream reflector that is positioned and supported by a downstream bluff body to reduce a portion of the ultrasonic signal path within a wake of the upstream reflector.

### FIELD OF THE INVENTION

This application relates to an ultrasonic flow meter insert, a tool for forming an ultrasonic flow meter insert and a method for forming an ultrasonic flow meter insert, the

insert having vertically offset reflectors. More particularly, the present application relates to such an insert, tool and method where one or more vertically offset reflectors are formed in the ultrasonic flow meter insert during formation of the insert.

### BACKGROUND

An ultrasonic flowmeter uses sound waves to determine the velocity of a fluid or gas travelling through a conduit. For expediency, the present application will refer to a fluid, but one or ordinary skill in the art would understand that the principles are similar for gases. The flowmeter includes two or more transducers spaced apart for each other that send and receive ultrasonic signals forward (with the direction of the flowing fluid) and backward (against the direction of the flowing fluid). When fluid is flowing through the conduit, the backward signal will travel slower and take more time than the forward signal. When the fluid moves faster, the difference between the forward and backward signal times increases.

Transit-time ultrasonic flowmeters rely on ultrasonic transducers to send a signal or “beam” at an angle from one side of a pipe to the other. The flowmeter calculates flowrate by comparing the difference between the “transit time” of the signal when it travels with the flow stream and when it travels against the flow stream. A signal path is the path of the ultrasonic signal as it travels between the sender and receiver transducers. The signal path may be straight across a conduit, may include a reflection across the conduit and back again, etc. Where the signal is reflected, the ultrasonic flowmeter uses a reflector to change the direction of the ultrasonic signal. A reflected signal extends the signal path, reducing any potential error caused by a non-uniform velocity profile, swirl, irregularities in the fluid, etc. A reflected signal further provides a longer signal path length, allowing for greater timing resolution, accounting for different flow pressures, providing more accurate average velocity measurement when the velocity field is not uniform, etc. A signal path is extended by each reflector changing the direction of the ultrasonic signal.

Ultrasonic flow meters use the path length of the signal to determine the velocity of the fluid being transported through the conduit. Designs that allow higher flow velocity to be captured greatly improves the accuracy of the measurement. However, due to the geometry of the design and reflective signal passage, the position of reflectors will partially obstruct the flow and create a wake behind the bluff body of the reflector and its positioning structure. The wake will disturb the measurement zone along the signal path.

Referring now to FIG. 1, a flow velocity computational fluid dynamics (CFD) plot 100 illustrating velocity according to a velocity scale 102 is shown depicting flow velocity through a cutaway view of a flow insert 110, according to an exemplary embodiment. Generally, not all fluid particles travel at the same velocity within a pipe. As shown on the inlet side 104 of CFD plot 100, the flow entering a flow insert is typically relatively uniform. The CFD plot representation of the velocity depends upon whether the flow is laminar or turbulent. A traditional flow entering a flow insert 100 may be a turbulent flow or a laminar flow, dependent in part on flow velocity. As shown in FIG. 1, where the flow is a turbulent flow, a fairly flat velocity distribution exists across the section of pipe at the inlet side 104, with the result that the entire fluid flows at a given single value. The velocity of the fluid in contact with the pipe wall is essentially zero and increases further away from the wall.

However, within a measurement area 120 of flow insert 110, an upstream bluff body 112 supporting a reflector 114 will create a wake in the flow. The wake will create both a low velocity zone 122 behind the bluff body 112 of the reflector 114 and a high velocity zone 124 caused by the redirection of flow by the bluff body 112. Accordingly, a measurement signal path 130 will pass through both low velocity zone 122 and high velocity zone 124, potentially compromising the accuracy of flow measurement through the flow insert 110.

Referring now also to FIG. 2, a perspective view of a cutaway flow insert 210 in situ within an ultrasonic flow meter body 200 is shown, according to an exemplary embodiment. An ultrasonic meter flow insert 210 is typically inserted into the ultrasonic flow meter body 200 for an ultrasonic flow meter (not shown) and is used to define the ultrasonic flow meter signal path 130, conditioning fluid flowing through the ultrasonic flow meter, supporting and fixing reflectors along the signal path, etc.

Flow insert 210 includes an insert body 212, the body 212 defining a fluid inlet 214, a fluid outlet 216 and a fluid conduit 218. Insert body 212 may be an injection molded component formed from injected plastic such as acrylic, polycarbonate, polyethylene, polypropylene, polystyrene, thermoplastic, elastomer, etc. as are known in the art. Although shown in an assembled state in FIG. 2, body 212 may include a top portion 222 and a bottom portion 224, further shown and described below with reference to FIG. 7 as an exemplary embodiment although various configurations may be used.

What is needed is an ultrasonic signal flow meter configured to be able to send and receive an ultrasonic signal that is less subject to accuracy variations. What is further needed is such an ultrasonic flow meter configured to improve the stability of the velocity flow stream within the measurement zone.

### SUMMARY

This application relates to a flow insert for an ultrasonic flowmeter configured to include vertically offset reflectors configured to reduce the effect of a wake along an ultrasonic signal path. The flow meter insert vertically offset reflectors are configured to force the wake away from the ultrasonic signal path within a measurement are within the flow insert.

One embodiment is directed to a flow insert for insertion in an ultrasonic meter transporting a flow stream. The flow insert includes an inlet side receiving the flow stream, an outlet side receiving the flow stream after the flow stream passes through the inlet side, a flow insert flow area between the inlet side and the outlet side, the flow insert flow area including an upper portion and a lower portion, and a flow measurement area defined by at least two transducer ports and at least an upstream and a downstream reflector defining an ultrasonic signal path through the flow measurement area, where the upstream reflector is positioned and supported by an upstream bluff body and is vertically offset from the downstream reflector that is positioned and supported by a downstream bluff body to reduce a portion of the ultrasonic signal path within a wake of the upstream reflector.

In one more detailed aspect, the insert further includes two or more longitudinal impressions protruding into upper portion of the flow insert flow area to further reduce a portion of the ultrasonic signal path within a wake of the upstream reflector. In another detailed aspect, wherein each longitudinal impression may include a decreasing radius along the length of the longitudinal impression.

In another more detailed aspect, a depth of each longitudinal impression is determined based on a measured wake effect of the upstream bluff body. Alternatively, the depth of the longitudinal impression varies based on the measured wake effect along different portions of the longitudinal impression.

Another embodiment of the invention is directed to a flow insert for insertion in an ultrasonic meter transporting a flow stream. The flow insert includes an inlet side receiving the flow stream, an outlet side receiving the flow stream after the flow stream passes through the inlet side, a flow insert flow area between the inlet side and the outlet side, the flow insert flow area including an upper portion and a lower portion, and a flow measurement area defined by at least two transducer ports and at least an upstream and a downstream reflector defining an ultrasonic signal path through the flow measurement area, where the upstream reflector is positioned and supported by an upstream bluff body and is vertically offset relative to the transducer ports from the downstream reflector that is positioned and supported by a downstream bluff body to reduce a portion of the ultrasonic signal path within a wake of the upstream bluff body.

Other features of the flow conditioning insert, besides those discussed above, will be apparent to those of ordinary skill in the art from the description of the preferred embodiments which follows. In the description, reference is made to the accompanying drawings, which form a part hereof, and which illustrate examples of the invention. Such examples are illustrative, but for the scope of the invention, reference is made to the claims which follow the description.

### BRIEF DESCRIPTION OF THE DRAWINGS

FIG. 1 is a cross section partial view showing a CFD plot illustrating velocity through a flow insert, according to an exemplary embodiment;

FIG. 2 is a perspective view of a cutaway flow insert in situ within an ultrasonic flow meter body, according to an exemplary embodiment;

FIG. 3A is a perspective view of an ultrasonic flow insert including two longitudinal impressions, according to an exemplary embodiment;

FIG. 3B is a cross-section view of an ultrasonic flow insert including two longitudinal impressions, according to an exemplary embodiment;

FIG. 3C is a perspective side cutaway view of an ultrasonic flow insert including two longitudinal impressions, according to an exemplary embodiment;

FIG. 4 is a graph showing a calibration curve illustrating effect before and after inclusion of the longitudinal impressions of FIG. 3A, according to an exemplary embodiment;

FIG. 5A is a side cross section perspective view of an ultrasonic flow insert including vertically offset reflectors and two longitudinal impressions, according to an exemplary embodiment;

FIG. 5B is a side cross section view of an ultrasonic flow insert including vertically offset reflectors, according to an exemplary embodiment;

FIG. 5C is a side cross section view of an ultrasonic flow insert including vertically offset reflectors, according to an exemplary embodiment;

FIG. 6 is a graph showing a calibration curve illustrating effect before and after inclusion of the vertically offset reflectors of FIG. 5A, according to an exemplary embodiment; and

FIG. 7 is a perspective view of an ultrasonic flow insert having separate upper and lower portions and including vertically offset reflectors and two longitudinal impressions, according to an exemplary embodiment, according to an exemplary embodiment.

### DETAILED DESCRIPTION OF THE INVENTION

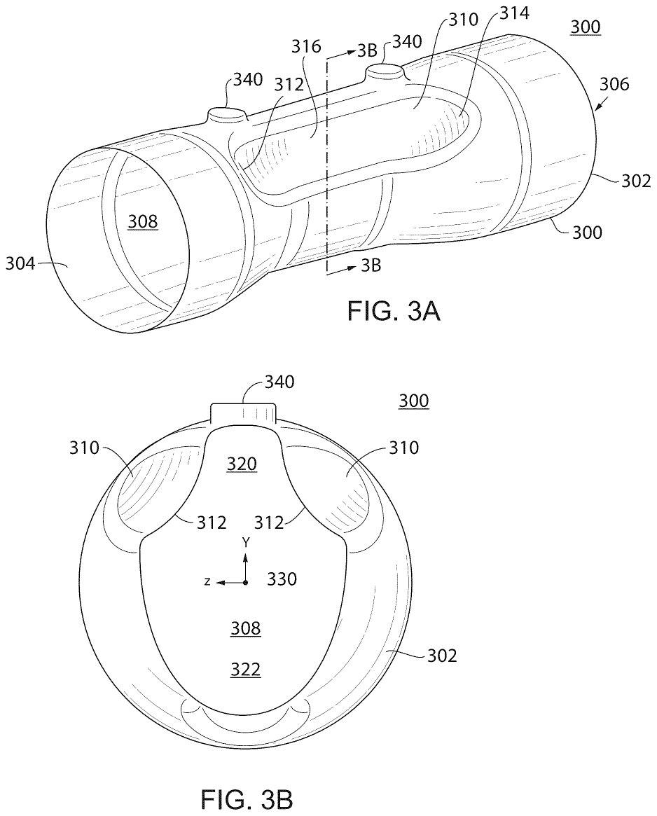

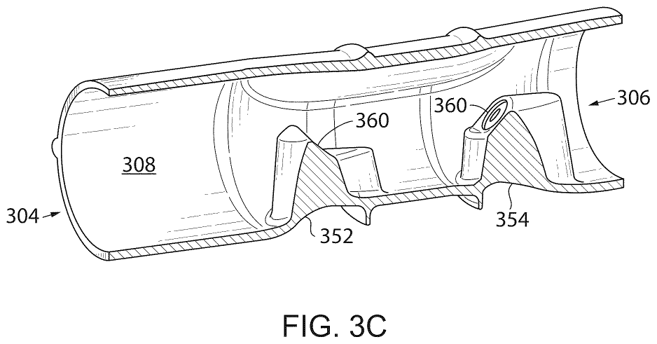

Referring now to FIGS. 3A-3C, an ultrasonic flow insert 300 including two or more longitudinal impressions 310 is shown, according to an exemplary embodiment. Flow insert 300 includes a flow insert body 302 having an upstream inlet 304, a downstream outlet 306, and a flow tube 308 therebetween. The longitudinal impressions 310 are configured to minimize the effect within the measurement area of the wake created in the flow caused by an upstream bluff body 352 supporting an upstream reflector 360.

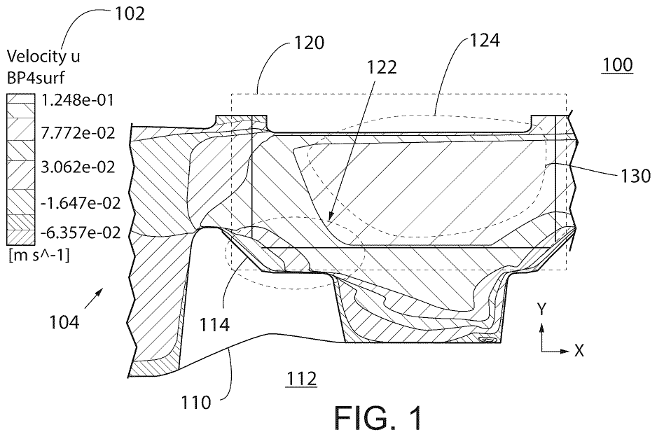

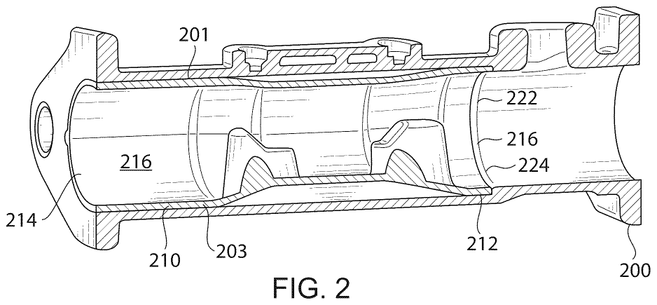

Flow insert 300 is configured to include at least two transducer ports 340 configured to receive ultrasonic signals from the ultrasonic transducers of a flow meter as shown and described above with reference to FIG. 1. Although a specific location, positioning and number of transducer ports are shown in FIGS. 3A-3C, one of ordinary skill in the art would understand that the invention described herein may be applied using different configurations.

Flow insert 300 further includes an upstream bluff body 352 and a downstream bluff body 354 configured to support reflectors 360. Although a specific location, positioning and number of bluff bodies and reflectors are shown in FIGS. 3A-3C, one of ordinary skill in the art would understand that the invention described herein may be applied different configurations. For example, although a U-bounce configuration is shown, the invention described herein may provide the benefits in any flow tube including features generating wake within a flow tube 308. Additionally, the present invention described herein may also be used with different combinations of meters with post or floor mounted reflectors as opposed to the bluff bodies 352 and 354 shown in FIG. 3C.

Longitudinal impressions 310 are configured to include a quarter-spherical upstream end 312 and a quarter-spherical downstream end 314 with half-cylinder center portion 316 extending therebetween. Each longitudinal impression 310 creates a corresponding longitudinal protrusion 312 extending into the flow tube 308.

Although the features in this case are shaped as radial impressions creating half-spherical ends 312 and 314 and half-cylinder center portion 316, impressions 310 may alternatively have shapes and/or configuration, some of which being described hereinbelow. Longitudinal impressions 310 extend along the longitudinal axis 330 of insert body 302. Longitudinal impressions 310 further extend into the flow through the flow tube 308 and will reduce the top part area 320 of the flow volume in the measurement area 320. Longitudinal impression 310 may be provided in conjunction with a larger area in the lower part area 322 of the measurement area 320 to accommodate a consistent cross-sectional area and reduce any potential pressure drop over the entire flow meter.

In an exemplary embodiment, longitudinal impressions 310 may be configured based on the size of a conduit receiving the flow insert 300. For example, for a ½-inch conduit, a radius of the half-cylinder center portion 316 may be 5-25 mm, according to an exemplary embodiment. In an alternative embodiment, for a 2-inch conduit, a radius of the half-cylinder center portion 316 may be 2-6 mm.

Alternatively, the radius of the longitudinal impressions 310 may be configured to reduce the size of the top part area 320 proportionally with the size of the flow area in flow tube 308. More specifically, protrusions 312 may be configured to reduce the size of top part area 320 as a fixed percentage of the overall area of the flow area of flow tube 308 to provide the advantages described herein.

Advantageously, the size, shape and position of longitudinal impressions 310 may be symmetrical. The advantage in having two symmetrical impressions on either side is to allow uninterrupted transmission through the transducer ports. An additional advantage of having symmetrical and opposite positioning is to facilitate purging benefits such that, when setting up the meter, the area between the longitudinal impressions is exposed to flow to evacuate trapped air.

In another exemplary embodiment, the length and/or positioning of the longitudinal impressions 310 may be configured based on the location of transducers of an ultrasonic meter and/or the location of reflectors and support structures for the reflectors. For example, as shown in FIG. 3A, longitudinal impressions 310 are configured to be positioned aligned with the transducer ports 340 of the flow insert 300. The upstream half-spherical end 312 will affect the flow stream through flow tube 308 contemporaneously with the introduction of wake by the upstream bluff body 362 shown in FIG. 3A.

The relative position of the longitudinal impressions relative to the bluff bodies may be configured based a variety of factors such as the degree of wake introduced, the type or profile of the medium flowing through the flow insert 300, the degree of the wake cause by the bluff body, etc. In a first example, the location half-spherical ends 312 may positioned upstream for the location of the upstream transducer port 340 such that the effect on the flow stream of the longitudinal impressions 310 is initiated prior to the introduction of the wake caused by a bluff body. In a second example, the location half-spherical ends 312 may positioned downstream of the location of the upstream transducer port 340 such that the effect on the flow stream of the longitudinal impressions 310 is initiated after the introduction of the wake caused by a bluff body.

Further, the overall shape of each longitudinal impression 310 may be configured based on the anticipated wake introduced by a bluff body. For example, referring to FIG. 1, the wake introduced by an upstream bluff body 112 may be initially large but decrease in a predictable manner downstream from the upstream bluff body 112 as shown. Accordingly, a longitudinal impression 310 may have a larger depth and/or protrusion into the flow body 308 that decreases along the length of the longitudinal impression 310 corresponding to the decrease in the effect of the wake from the bluff body.

Referring now specifically to FIG. 3B, longitudinal impressions 310 are positioned approximately 30 degrees down from the top center position along the circumference of the flow insert 300. Advantageously, in a typical design with two reflectors 360 and top mounted transducer ports 340 from an ultrasonic flow meter, lowering the entire measurement area 320 or flow field will force the majority of the higher velocity flow stream to pass between the reflectors 360 and within the measured area.

In another alternative embodiment, the degree down from the top center position along the circumference of the flow insert 300 may vary along the length of each longitudinal impression 310 to correspond with the changing effect of the wake introduced by the upstream bluff body 352. For example, a longitudinal impression 310 may be positioned approximately 30 degrees down from the top center position along the circumference of the flow insert 300 at the start of the longitudinal impression and approximately 60 degrees down from the top center position along the circumference of the flow insert 300 at the terminus of the longitudinal impression.

Positioning the longitudinal impressions 310 down along the circumference of the flow insert 300 avoids the problem created by a top positioned reduction in the flow area 308 that can create an issue with trapped air at the transducer location. Specifically, in the measurement zone of a flow meter, longitudinal impressions 310 located in upper half of the flow insert 300 will force the flow to change path into the area between the reflectors where majority of the velocity is measured. This also allows for a passage at the upper part 320 of the flow volume to maintain a certain level of flow which is important for trapped air to be evacuated and to avoid a pressure drop.

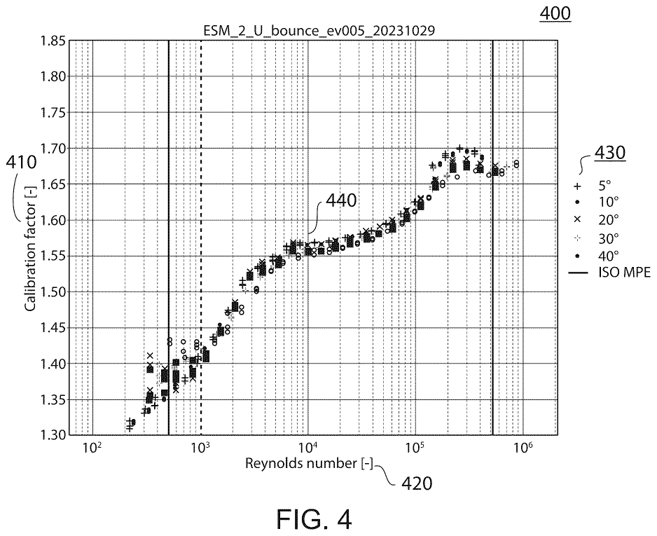

Referring now to FIG. 4, a graph 400 illustrates a calibration curve 440 illustrating effect of the longitudinal impressions of FIG. 3A, according to an exemplary embodiment. The graph 400 illustrate the calibration factor 410 requirements for different Reynolds numbers 420, each plot line 430 illustrating slope at different temperature increments in degrees Celsius. The calibration factor 410 represents the amount of calibration required at different Reynolds number values 420 to properly calibrate the ultrasonic flow meter. The Reynolds number 420 is used to help predict fluid flow patterns in different situations by measuring the ratio between inertial and viscous forces. At low Reynolds numbers, flows tend to be dominated by laminar (sheet-like) flow, while at high Reynolds numbers, flows tend to be turbulent.

A calibration curve is considered desirable wherein the spread along the slope is relatively tightly grouped within even unstable flow regions while also avoiding areas of negative slope. As shown in graph 400, longitudinal impressions 310 are used to keep the effective measurement area 320 the same while also forcing a major part of high velocity zone to be concentrated to the measurement zone. Pressure loss is reduced due to the wider sections of the measurement area 320, remote from longitudinal impressions 310, around reflectors 360.

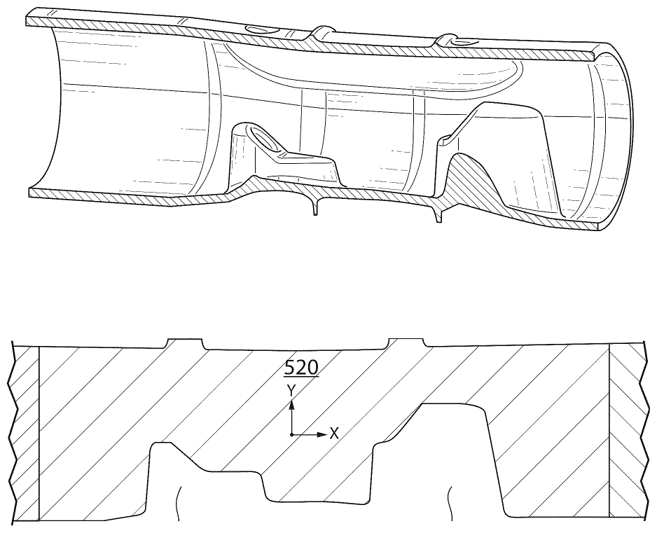

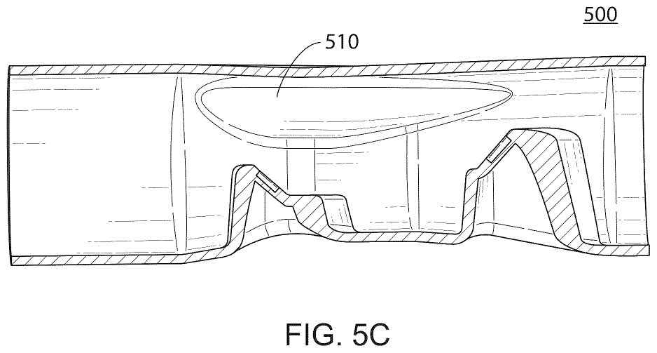

Referring now to FIGS. 5A-C, an ultrasonic flow insert 500 including two or more vertically offset bluff bodies 550 including an upstream bluff body 532 and a downstream bluff body 534 is shown, according to an exemplary embodiment. Flow insert 500 includes a flow insert body 502 having an upstream inlet 504, a downstream outlet 506, and a flow tube 508 therebetween.

Flow insert 500 is configured to include at least two transducer ports 540 configured to receive ultrasonic signals from the ultrasonic transducers of a flow meter as shown and described above with reference to FIG. 1. Although a specific location, positioning and number of transducer ports are shown in FIGS. 5A-5B, one of ordinary skill in the art would understand that the invention described herein may be applied to different configurations.

Flow insert 500 further includes an upstream bluff body 532 and a downstream bluff body 534 configured to support reflectors 560. Although a specific location, positioning and number of bluff bodies and reflectors are shown in FIGS. 3A-3C, one of ordinary skill in the art would understand that the invention described herein may be applied different configurations. For example, although a U-bounce configuration is shown, the invention described herein may provide the benefits in any flow tube including features generating wake within a flow tube 508.

Advantageously, using two reflectors supported by bluff bodies 550 vertically offset from each other, the measured path of the ultrasonic signal is moved away from the low velocity zone inherently downstream from the upstream bluff body 532 as shown in FIG. 1 and into the area of undisturbed flow.

Using the flow insert of FIG. 5A, ultrasonic flow meter where two reflectors are used to transmit the acoustic signal, with reflectors positioned at a vertical offset from each other. The measured vertical offset ratio can be between 1/25 up to ⅘ of the flow area diameter according to alternative embodiments.

In an exemplary embodiment, flow insert 500 may further be configured to include two or more longitudinal impressions 510. The longitudinal impressions 510 are configured to minimize the effect within the measurement area of the wake created in the flow caused by an upstream bluff body 532 supporting an upstream reflector 560.

Referring now to FIG. 5C, a flow insert 500 may be configured to include longitudinal impressions 510 that are configured based on the vertical offset between bluff bodies. For example, a longitudinal offset end proximate to a lower bluff body may extend further into the flow area to force a greater displacement of fluid from a top area of the flow insert 500. Similarly, a longitudinal offset end proximate to a higher bluff body may extend less into the flow area to force a less displacement of fluid from a top area of the flow insert 500.

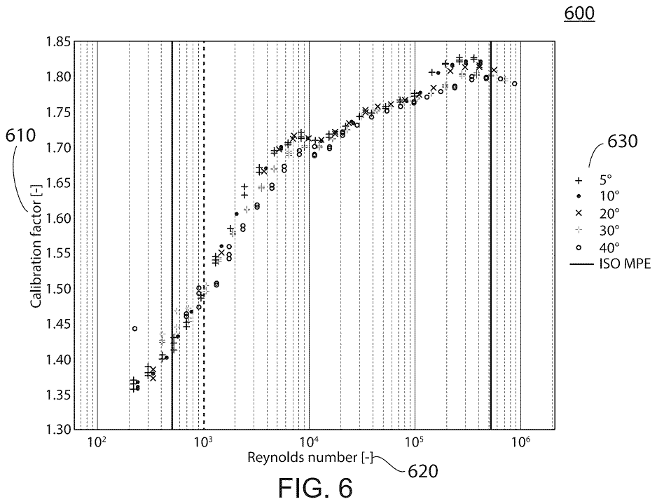

Referring now to FIG. 6, a graph 600 illustrates a calibration curve 640 illustrating effect of the vertically offset reflectors of FIG. 5A, according to an exemplary embodiment. The graph 600 illustrate the calibration factor 610 requirements for different Reynolds numbers 620, each plot line 630 illustrating slope at different temperature increments in degrees Celsius. The calibration factor 610 represents the amount of calibration required at different Reynolds number values 620 to properly calibrate the ultrasonic flow meter. The Reynolds number 620 is used to help predict fluid flow patterns in different situations by measuring the ratio between inertial and viscous forces.

A calibration curve 640 is considered desirable wherein the spread along the slope is relatively tightly grouped within even unstable flow regions while also avoiding areas of negative slope. As shown in graph 600, introducing offset reflectors 560 are used to keep the effective measurement area 520 the same while also avoiding the low-pressure zone introduce by the upstream bluff body 532.

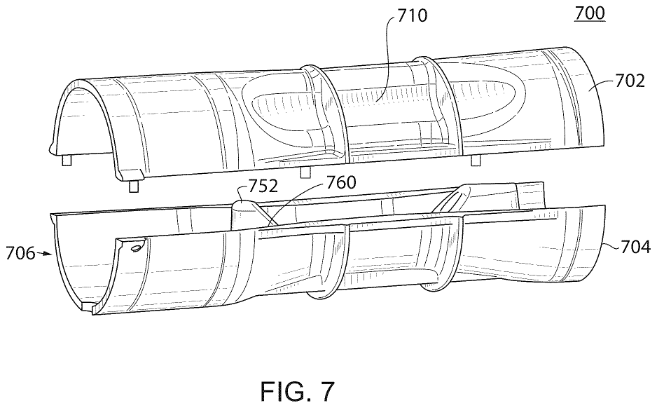

Referring now to FIG. 7, an ultrasonic flow insert 700 including two or more longitudinal impressions 710 is shown, according to an exemplary embodiment. Flow insert 700 includes an upper portion 702 and a lower portion 704 that form a flow tube 706 therebetween in an assembled state. The longitudinal impressions 710 positioned in the upper portion 702 to minimize the effect within the measurement area of the wake created in the flow caused by an upstream bluff body 752 supporting an upstream reflector 760 in the lower portion 704.

Advantageously, providing a flow insert 700 having an upper portion 702 and a lower portion 704 allows a user to modify the operation of the flow insert 700 by selecting different upper portions 702 having differently sized or shaped longitudinal impressions 710. For example, a upper portion 702 having larger longitudinal impressions 710 may be selected based on anticipated flow patterns that will be typical for the intended use of flow insert 700.

This has been a description of exemplary embodiments, but it will be apparent to those of ordinary skill in the art that variations may be made in the details of these specific embodiments without departing from the scope and spirit of the present invention, and that such variations are intended to be encompassed by the following claims.

What is claimed is:

1. A flow insert for insertion in an ultrasonic meter transporting a flow stream, comprising:
an inlet side including receiving the flow stream;
an outlet side receiving the flow stream after the flow stream passes through the inlet side;
a flow insert flow area between the inlet side and the outlet side, the flow insert flow area including an upper portion and a lower portion; and
a flow measurement area defined by at least two transducer ports and at least an upstream and a downstream reflector defining an ultrasonic signal path through the flow measurement area;
where the upstream reflector is positioned and supported by an upstream bluff body and is vertically offset from the downstream reflector that is positioned and supported by a downstream bluff body to reduce a portion of the ultrasonic signal path within a wake of the upstream bluff body.

2. The flow insert of claim 1, wherein the angle of the reflector supported by the upstream bluff body is different from angle of the reflector supported by the downstream bluff body relative to a proximate transducer port.

3. The flow insert of claim 1, further including two or more longitudinal impressions protruding into upper portion of the flow insert flow area to further reduce a portion of the ultrasonic signal path within a wake of the upstream reflector.

4. The flow insert of claim 3, wherein each longitudinal impression includes a decreasing radius along the length of the longitudinal impression.

5. The flow insert of claim 4, wherein a depth of each longitudinal impression is determined based on a measured wake effect of the upstream bluff body.

6. The flow insert of claim 4, wherein the depth of the longitudinal impression varies based on the measured wake effect along different portions of the longitudinal impression.

7. A flow insert for insertion in an ultrasonic meter transporting a flow stream, comprising:
an inlet side including receiving the flow stream;
an outlet side receiving the flow stream after the flow stream passes through the inlet side;
a flow insert flow area between the inlet side and the outlet side; and
a flow measurement area defined by at least two transducer ports and at least an upstream and a downstream reflector defining an ultrasonic signal path through the flow measurement area;
where the upstream reflector is positioned and supported by an upstream bluff body and is vertically offset relative to the transducer ports from the downstream reflector that is positioned and supported by a downstream bluff body to reduce a portion of the ultrasonic signal path within a wake of the upstream bluff body.

8. The flow insert of claim 7, wherein the angle of the reflector supported by the upstream bluff body is different from angle of the reflector supported by the downstream bluff body relative to a proximate transducer port.

9. The flow insert of claim 7, further including two or more longitudinal impressions protruding into upper portion of the flow insert flow area to further reduce a portion of the ultrasonic signal path within a wake of the upstream reflector.

10. The flow insert of claim 9, wherein each longitudinal impression includes a decreasing radius along the length of the longitudinal impression.

11. The flow insert of claim 10, wherein a depth of each longitudinal impression is determined based on a measured wake effect of the upstream bluff body.

12. The flow insert of claim 10, wherein the depth of the longitudinal impression varies based on the measured wake effect along different portions of the longitudinal impression.
